(19) United States
(12) Patent Application Publication
(10) Pub. No.: US 2023/0127893 A1
(43) Pub. Date: Apr. 27, 2023

(54) INFORMATION PROCESSING DEVICE

(71) Applicant: Faurecia Clarion Electronics Co., Ltd., Saitama-shi (JP)

(72) Inventor: Masashi OOTSUKA, Saitama (JP)

(73) Assignee: Faurecia Clarion Electronics Co., Ltd., Saitama-shi (JP)

(21) Appl. No.: 17/963,720

(22) Filed: Oct. 11, 2022

(30) Foreign Application Priority Data
Oct. 25, 2021 (JP) 2021-173788

(51) Int. Cl. G01C 21/36; G01C 21/32; G01C 21/00

(52) U.S. Cl. CPC G01C 21/367; G01C 21/32; G01C 21/3811; G01C 21/387

(57) ABSTRACT

[Problem]

To display the current location of a user appropriately on a deformed map.

[Means for Resolution]

An information processing device, comprising: a measuring unit for measuring location information for a current location; a mapping processing unit for converting the location information for the current location into first map coordinates in a first map, for a navigation application, that includes the current location, and for using a conversion table to convert the first map coordinates into second map coordinates in a second map wherein the first map has been abstracted; and a display controlling unit for displaying, on a display, the second map, on which has been placed, at the second map coordinates, a mark that indicates the current location, wherein: the second map coordinates in a second coordinate system with the same scale as the first coordinate system, provided in the second map, are recorded in the conversion table in correspondence with the first map coordinates of the first coordinate system that are provided in the first map.

### FIELD OF TECHNOLOGY

The present invention relates to an information processing device.

### PRIOR ART

In navigation systems, instead of displaying a map for navigation (hereinafter termed a “navigation map”) that shows accurately the actual road lengths and directions, layouts of buildings, and the like, in predetermined facilities or areas (for example, service areas by high-speed thoroughfares), maps that show these abstractly (termed “deformed maps”) are displayed instead.

The purpose of a deformed map is to facilitate intuitive understanding by a user. Therefore, the lengths and directions of the actual roads, the layouts of the buildings, and the like, are not necessarily depicted accurately. Thus, it makes difficult to indicate the current location on a deformed map, and normally the current location is not displayed.

When it comes displaying the current location on a deformed map, patent Document 1, for example, discloses a mobile navigation device for displaying an image of a deformed map wherein the road shapes are different from that which is actual, and for displaying the current location on the image, comprising: a map data storing unit for storing image data of the deformed map; a walking route information database wherein information identifying a plurality of walking routes that are subject to navigation, coordinates, on the deformed map, of a plurality of specific locations placed on a plurality of the walking paths that have been identified, and actual latitude and longitude coordinates of the plurality of specific locations are stored in correspondence with each other; a device main unit location information acquiring unit for acquiring latitude and longitude coordinate information of the current location that is the location of the device main unit of the navigation device; a processing unit for performing predetermined calculations and information processing; and a displaying unit for receiving a command from the processing unit to display an image of the deformed map that is stored in the map data storing unit and also to display, on the image, a mark indicating the current location of the device main unit, wherein: the processing unit identifies a walking route by approximating a straight line based on the latitude and longitude coordinates of a plurality of specified locations registered in the walking route information database, calculates, from the plurality of latitude and longitude coordinates on the identified walking route, the latitude and longitude coordinates of the location nearest to the latitude and longitude coordinates of the device main unit which were acquired by the main unit location information acquiring unit, converts the calculated latitude and longitude coordinates to coordinates on the deformed map, and issues a command to the displaying unit to display the mark at the location, on the deformed map, of the coordinates obtained through the conversion.

### PRIOR ART DOCUMENT

### Patent Document

### Patent Document 1

Japanese Unexamined Patent Application Publication 2016-61621

### SUMMARY OF THE INVENTION

### Problem Solved by the Present Invention

The navigation device described in Patent Document 1 enables a mark indicating the current location of a user to be displayed on a deformed map at the point on a walking route of that is nearest to the actual latitude and longitude coordinates of the user. However, the mark indicating the current location of the user will be displayed on the walking route even if the user is at a location that is not on the walking route. Thus the mark that indicates the current location of the user cannot be displayed at the appropriate location on the deformed map.

The present invention was created in contemplation of this situation, and the object thereof is to enable the current location of the user to be displayed at an appropriate location on the deformed map.

### Means for Solving the Problem

While the present application includes a plurality of means for solving, at least in part, the problem according to above, an example thereof includes the following:

In order to solve the problems according to above, and information processing device that is one aspect of the present invention comprises: a measuring unit for measuring location information for a current location; a mapping processing unit for converting the location information for the current location into first map coordinates in a first map, for a navigation application, that includes the current location, and for using a conversion table to convert the first map coordinates into second map coordinates in a second map wherein the first map has been abstracted; and a display controlling unit for displaying, on a display, the second map, on which has been placed, at the second map coordinates, a mark that indicates the current location, wherein: the second map coordinates in a second coordinate system with the same scale as the first coordinate system, provided in the second map, are recorded in the conversion table in correspondence with the first map coordinates of the first coordinate system that are provided in the first map.

### Effects of the Invention

The one aspect of the present invention enables displaying of the location that is the current location of the user appropriately on the deformed map.

Other objects, structures, and effects will become apparent through explanations of embodiments, below.

### BRIEF DESCRIPTIONS OF THE DRAWINGS

FIG. 1 is a block diagram showing an example configuration of a vehicle-mounted device according to one embodiment according to the present invention.

FIG. 2 is a diagram showing an example of functional blocks of the vehicle-mounted device.

FIG. 3 is a diagram showing an example of a navigation map and a deformed map.

FIG. 4 is a diagram showing an example of the correspondence relationship between the navigation map coordinates and the deformed map coordinates.

FIG. 5 is a diagram showing an example of a conversion table.

FIG. 6 is a flowchart for explaining an example of a current location displaying process.

FIG. 7 is a diagram showing an example display of a deformed map that includes a mark indicating the current location.

### FORMS FOR PERFORMING THE PRESENT INVENTION

One embodiment according to the present invention will be explained below based on the drawings. Note that in all drawings for explaining the embodiment, in principle identical reference symbols will be assigned to identical members, and redundant explanations thereof will be omitted as appropriate. Additionally, in the embodiment according to below the structural elements (including element steps, and the like) are not necessarily essential, of course, unless explicitly indicated as such or unless clearly required in principle. Moreover, the terms “comprising A,” “made from A,” “having A,” and “including A” do not, of course, indicate that other elements are necessarily absent, except for cases wherein it is indicated explicitly that there is only that element. Similarly, in the embodiments according to below, references to shapes, positional relationships, and the like, of the structural elements, and the like, include approximations or similarities that are substantially those shapes, or the like, except for when stated explicitly or when clearly one may be led by principal to believe otherwise.

### Example of Structure of Vehicle-Mounted Device 10 According to One Embodiment According to the Present Invention

A vehicle-mounted device 10 according to one embodiment of the present invention will be explained below. The vehicle-mounted device 10 corresponds to the “information processing device” of the present invention.

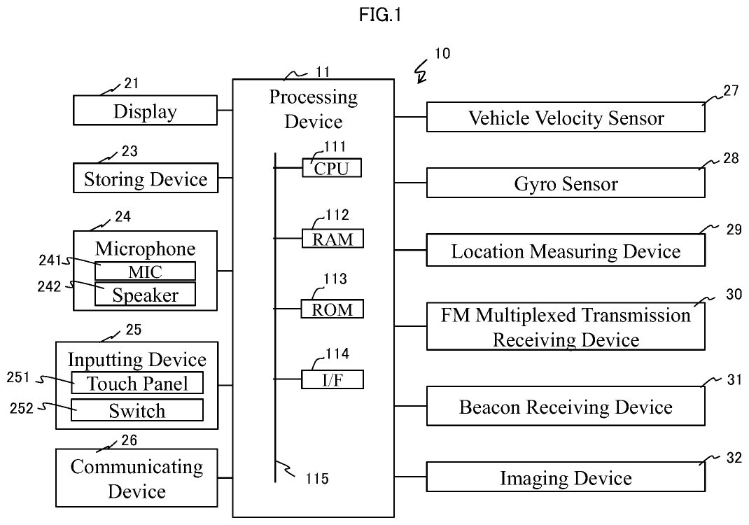

FIG. 1 shows an example structure for a vehicle-mounted device 10 according to one embodiment of the present invention. The vehicle-mounted device 10 can be achieved through, for example, a vehicle-mounted navigation device that has a navigation function. For this, the vehicle-mounted device 10 is, for example, a box-shaped device comprising a display 21 on the front face thereof, and is contained in the console panel in an automobile. The vehicle-mounted device 10 comprises mounting hardware (a bracket) for mounting in the console panel. And it may be mounted on the console panel, or the like, in a vehicle through the mounting hardware.

Here the “navigation function” is the functions that are provided in a normal navigation device, that of displaying map information, route search and providing guidance from a point of departure (which is normally the current location) to a destination, and displaying traffic information. Note that the vehicle-mounted device 10 is not limited to a dedicated navigation device, but rather may be, for example, a smart phone, a tablet computer, or the like. The navigation function is provided by an application program that is installed in the device, or through a server device to which the device is connected. When comprising a smart phone, tablet computer, or another mobile electronic device, the navigation function includes not only vehicle route search for vehicles, but also walking route search for pedestrians and bicycle routes search for bicyclists.

The vehicle-mounted device 10 may display not only a navigation screen for a navigation function, but also an air conditioner screen for setting the temperature, flow rate, and the like, for an air conditioner, an AV screen for selecting an audio or video to playback, and for adjusting the volume, image quality, and the like, of playback, screens for applications that are executed on smart phones that are connected wirelessly (web browsers, mailers, SNS (Social Network Services), and the like, a telephone screen for placing and receiving telephone calls, a camera screen for showing images captured by a vehicle-mounted camera, and the like.

The vehicle-mounted device 10 has a processing device 11, a display 21, a storing device 23, an audio device 24, an inputting device 25, and a communicating device 26.

The vehicle-mounted device 10 has a vehicle velocity sensor 27, a gyro sensor 28, a location measuring device 29, an FM multiplexed broadcast receiving device 30, a beacon receiving device 31, and an imaging device 32.

The processing device 11 is a central unit that performs a variety of processes of the vehicle-mounted device 10. The processing device 11 may, for example, detect the current location using information outputted from various types of sensors and location measuring devices 29, such as the vehicle velocity sensor 27. Moreover, based on the current location that has been detected, the processing device 11 reads out, from the storing device 23, the map information required for the display. Additionally, the processing device 11 deploys into graphics the map information that has been read out, to generate and output an image signal, for displaying on the display 21, by superimposing thereon a mark that indicates the current location. Furthermore, the processing device 11 uses map information, and the like, stored in the storing device 23, to calculate a recommended path from the current location to a destination that has been set by the user (the driver or a passenger). In addition, the processing device 11 outputs a predetermined image signal to the display 21 to control the display of screens for navigation along the route. Moreover, the processing device 11 outputs predetermined audio signals to a speaker 242 to control the audio output for providing guidance.

Such a processing device 11 comprises: a processor such as a CPU (Central Processing Unit) 111 for executing various processes such as quantitative calculations and controlling various devices, a RAM (Random Access Memory) 112 for temporarily storing map information, calculation data, and the like, read out from a memory device such as the storing device 23 or the ROM 113, a ROM 113 for storing the boot program, or the like, to be by the CPU 111, an interface 114 for connecting various types of hardware to the processing device 11, and a bus 115 for connecting between the above.

The display 21 is arranged in the center of the console panel that is provided, for example, toward the front within an automobile. The display 21 may be structured from, for example, a liquid crystal display, an organic EL display, or the like. A transparent touch panel 251 is layered on the display 21. This enables the user to perform touch operations on the display 21 (on the touch panel 251 that is layered thereon). Note that operations on the display 21 may also be performed using switches 252.

The storing device 23 is structured from a storage media that is readable/writable, such as an HDD (Hard Disk Drive), an SSD (Solid State Drive), and/or a non-volatile memory card. For example, a variety of information (such as, for example, map information, and the like) that is used by the processing device 11 is stored in the storing device 23.

The audio device 24 has a microphone 241 as an audio inputting device and a speaker 242 as an audio outputting device. The microphone 241 collects sound from outside of the vehicle-mounted device 10, such as the voice of the driver or a passenger (user utterances). Additionally, the speaker 242 outputs sound such as route guidance, or the like, generated by the processing device 11, to the driver, or the like.

The inputting device 25 is a device for receiving instructions inputted from the user. The inputting device 25 is structured from a touch panel 251 that is layered on the display screen of the display 21, along with various types of switches 252. The inputting device 25 outputs information in accordance with the instructions inputted from the user to other devices such as the processing device 11.

The communicating device 26 is structured from, for example, a mobile telephone module. The communicating device 26 connects to a predetermined server through a network (not shown), such as a mobile telephone communication network or the Internet, or the like. And it receives predetermined information (for example, updated application programs, map information, and the like).

The vehicle velocity sensor 27 acquires values used for calculating the vehicle velocity. The gyro sensor 28 is structured from an optical fiber gyro or vibration gyro, or the like, and detects angular velocity caused by rotation of the mobile unit (the vehicle). The location measuring device 29 receives location measurement signals transmitted from a satellite for location measurement such as a GPS (Global Positioning System) satellite, to measure the current location (the longitude, latitude, and altitude) of the mobile unit based on the location measurement signals that have been received. The location measuring device 29 corresponds to the “measuring unit” in the present invention.

The outputs of the vehicle velocity sensor 27, the gyro sensor 28, and the location measuring device 29 are used by the processing device 11 to detect the current location, speed, and direction of travel of the vehicle in which the vehicle-mounted device 10 is mounted.

The FM multiplexed broadcast receiving device 30 receives FM multiplexed broadcasts transmitted using an FM signal. The FM multiplexed broadcasts include general current traffic information of VICS (Vehicle Information and Communication System) information, closure information, SA/PA (Service Area/Parking Area) information, parking lot information, weather information, and text information as FM-multiplexed general information.

The beacon receiving device 31 receives general current traffic information of VICS information, and the like, closing information, SA/PA information, parking lot information, weather information, emergency warnings, and the like. The beacon receiving device 31 is an optical beacon that communicates via light, a radio beacon that communicates via radio signals, or the like.

The imaging device 32 is a so-called vehicle-mounted camera, which captures images of the inside and outside of the vehicle (to the front, rear, and sides of the vehicle).

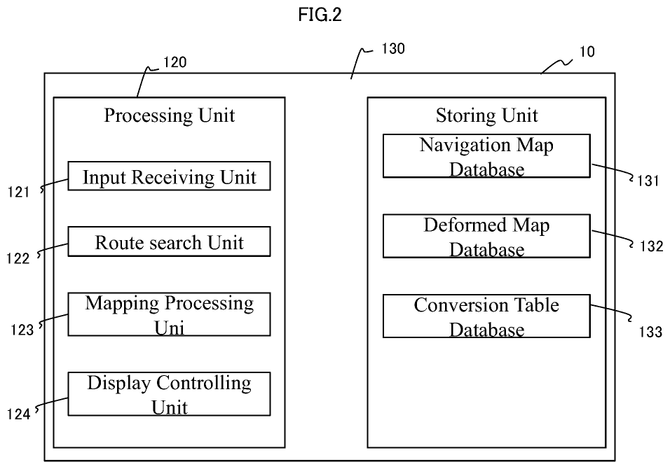

The functional blocks that show the functional structure of the vehicle-mounted device 10 will be explained next. FIG. 2 shows an example of functional blocks of a vehicle-mounted device 10.

The vehicle-mounted device 10 has a processing unit 120 and a storing unit 130.

The processing unit 120 is achieved through the execution, by the processing device 11, of the program loaded in the RAM 112 or recorded in advance in the ROM 113. The processing unit 120 has an input receiving unit 121, a route search unit 122, a mapping processing unit 123, and a display controlling unit 124.

The input receiving unit 121 receives input of instructions or information from a user through the inputting device 25. For example, the input receiving unit 121 receives, from the user, operations for setting the destination, for directing a search for a recommended route, or the like.

The route search unit 122 performs route search from the current location to the destination that is set by the user, to generate a recommended route.

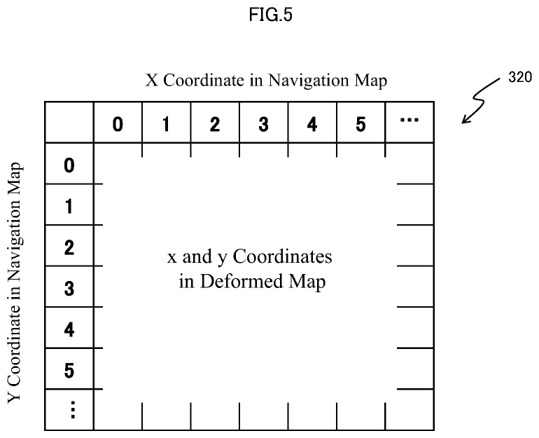

The mapping processing unit 123 reads the navigation map including the current location from the navigation map database 131 that is stored in the storing unit 130, and performs mapping the location information (latitude and longitude) of the current location that is measured by the location measuring device 29 on the navigation map. That is, the location information of the current location is converted into navigation map coordinates (X, Y) on the navigation map. When the deformed map corresponding to the navigation map including the present position exists in the deformed map DB 132 that is stored the storing unit 130, the mapping processing unit 123 refers to the conversion table 320 (FIG. 5) to convert the navigation map coordinates (X, Y) representing the present position on the navigation map into deformed map coordinates (x, y) representing the present position on the deformed map.

The navigation map and navigation map coordinates correspond to the first map and the first map coordinates of the present invention, and the deformed map and the deformed map coordinates correspond to the second map and the second map coordinates of the present invention.

The display controlling unit 124 reads the navigation map that includes the current location from the navigation map database 131 that is stored by the storing unit 130, and places a mark that indicates the current location at the navigation map coordinates (X, Y) of the current location, and displays the result on the display 21. Additionally, when the route guidance is being executed, the display control unit 124 superimposes the recommended route generated by the route search unit 122 on the navigation map and displays it on the display 21. Moreover, when a deformed map corresponding to the navigation map including the current location exists, the display controlling unit 124 reads the deformed map from the deformed map database 132 that is stored by the storing unit 130 places a mark indicating the current location at the deformed map coordinates (x, y) of the current location, and displays the result on the display 21.

The storing unit 130 is achieved through the ROM 113 and the storing device 23. The navigation map database 131, the deformed map database 132, and the conversion table database 133 are stored in the storing unit 130. Note that other information and data, other than that which is described above, may also be stored in the storing unit 130. Note that the storing unit 130 may be achieved instead through a predetermined server to which there is a connection through a network by the communicating device 26.

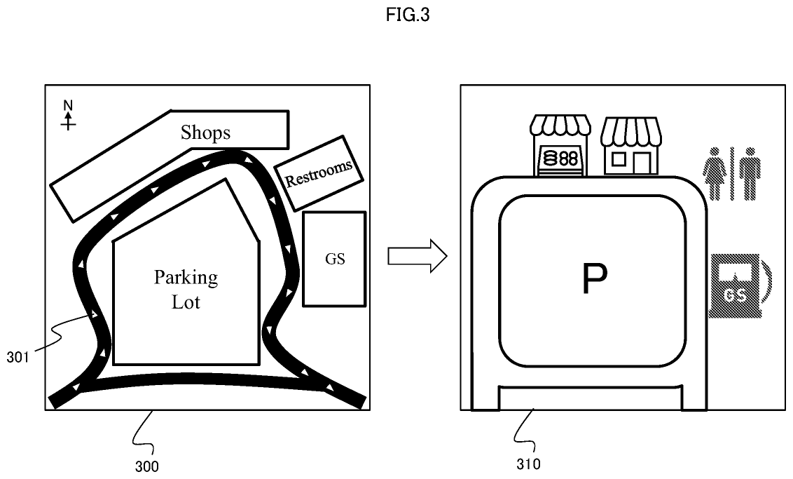

A navigation map 300 (FIG. 3) is stored in correspondence with location information for various locations, in the navigation map database 131 (FIG. 3). Corresponding deformed map information that indicates whether or not a corresponding deformed map exists in the deformed map database 132, and which indicates the display area of the deformed map, is added to the navigation map 300. For example, a deformed map 310 (FIG. 3) that corresponds to the location information of a predetermined area such as, for example, a service area, a parking area, or the like, is stored in advance in the deformed map database 132.

A conversion table database 133 stores, in advance, corresponding conversion tables 320 (FIG. 5) for each of the individual deformed maps that are stored in the deformed map database 132.

Each of the functional blocks shown in FIG. 2 is partitioned depending on the primary processing detail thereof, for ease in understanding the functions of the vehicle-mounted device 10 that is achieved in the present embodiment. Consequently, the present invention is not limited to the ways in which the individual functions are partitioned, nor by the names applied thereto. Additionally, each of the individual structures of the vehicle-mounted device 10 may be partitioned into a greater number of structural elements depending on the details of processing. Moreover, the partitioning may be such that more processes are performed by a single structural element.

All or part of each functional block may be structured through hardware that is mounted into a computer (that is, through an integrated circuit known as an ASIC). Furthermore, the processes in each individual functional block may be executed by a single hardware element, or executed by a plurality of hardware elements.

The relationships between the navigation map 300 (FIG. 3), the deformed map 310 (FIG. 3), and the conversion table 320 (FIG. 5) will be explained next.

FIG. 3 shows an example of a navigation map 300 and a deformed map 310 that corresponds thereto.

The navigation map is a map that reflects accurately the lengths and directions of actual roads and the arrangement of facilities such as parking lots (P), stores, restrooms, gas stations (GS), and the like. The navigation map 300 has link information indicating the locations of roads that can be traveled by vehicles and locations of parking lots and gas stations that can be reached by vehicles, and thus the actual location information for the current location can be mapped onto a road, parking lot, gas station, or the like, of the navigation map 300. That is, the actual location information can be converted directly into navigation map coordinates (X, Y). Thus, a mark 301 that indicates the current location can be displayed on the navigation map 300.

On the other hand, the actual lengths and directions of roads and layouts of facilities are not necessarily reflected accurately in a deformed map 310. Moreover, because normally the deformed map 310 is drawn or generated as a single image and does not have link information, the actual location information for the current location cannot be mapped onto the deformed map. That is, the actual location information cannot be converted directly into deformed map coordinates (x, y). Thus, the mark that indicates the current location cannot be displayed on the deformed map 310.

Here, in the present embodiment, the conversion table 320 is used to convert the actual location information for the current location indirectly, via the navigation map coordinates (X, Y), into deformed map coordinates (x, y).

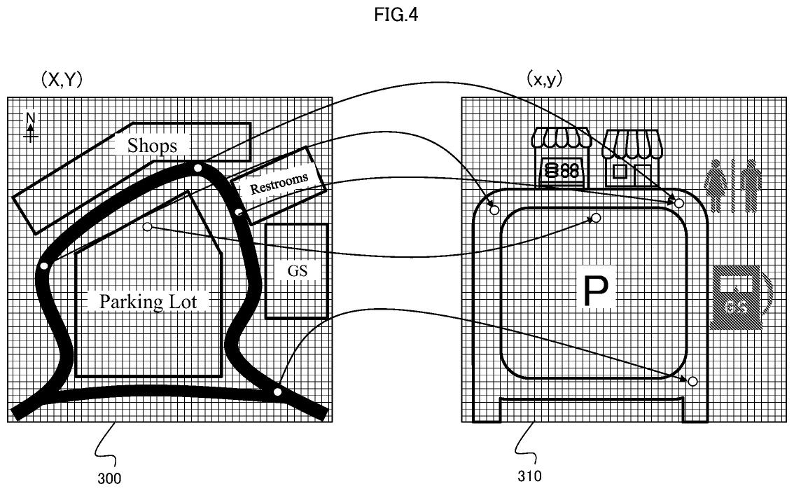

FIG. 4 shows an example of the correspondence relationships between the navigation map coordinates (X, Y) in a grid-shaped first coordinate system (orthogonal coordinate system) that is established in the navigation map 300, and the deformed map coordinates (x, y) in a grid-shaped second coordinate system (orthogonal coordinate system) that is established in the deformed map 310. Note that for the first coordinate system and the second coordinate system, the scales thereof are identical. The first coordinate system that is established in the navigation map 300 and the second coordinate system that is established in the deformed map are not limited to being orthogonal coordinate systems, but may use other coordinate systems instead.

The navigation map coordinates (X, Y) in the navigation map 300 are assigned a 1:1 or many:1 correspondence with the deformed map coordinates (x, y) in the deformed map 310.

FIG. 5 shows an example of a conversion table 320. The conversion table 320 is, for example, a matrix that has the X coordinates of the navigation map coordinates as a row (the horizontal axis) and the Y coordinates as a column (the vertical axis), where the deformed map coordinates (x, y) are stored as the X row-Y column components.

It is envisioned that the conversion table 320 will be generated by the creator, or the like, of the deformed map 310 determining and inputting the correspondence between the navigation map coordinates (X, Y) and the deformed map coordinates (x, y). However, the deformed map 310 and the conversion table 320 may instead be generated through the use of a computer, or the like, by inputting the navigation map 300 and following a predetermined algorithm.

Note that when the current location of the vehicle is displayed, it would not be appropriate for the mark that indicates the current location of the vehicle to be placed on a facility such as a store, restroom, or the like, that cannot be reached by a vehicle. Therefore, in the conversion table 320 the correspondence between the multiple navigation map coordinates (X, Y) that are occupied by shops or restrooms in the navigation map 300 may be assigned correspondence with deformed map coordinates (x, y) at one point on the road in front of the shop or restroom, avoiding shops and restrooms wherein it would be undesirable for the mark that indicates the current location of the vehicle to be placed in the deformed map 310.

Moreover, when displaying the current location of a user who is a pedestrian, it would not be a problem if the mark that indicates the current location of the user were to be placed on a facility such as a shop or a restroom. Thus, a conversion table for pedestrians may be prepared, with the multiple navigation map coordinates (X, Y) occupied by shops and restrooms in the navigation map 300, for example, assigned corresponding to individual points at the centers of the shops or restrooms in the deformed map 310.

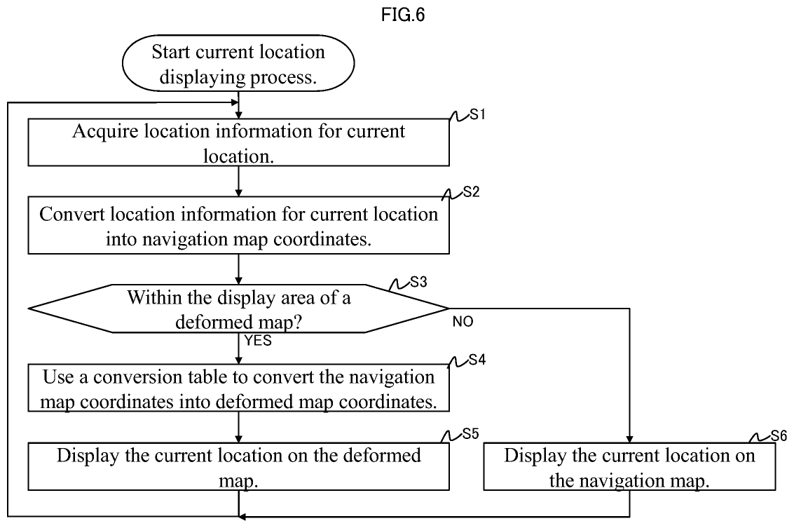

FIG. 6 is a flowchart for explaining an example of the current location displaying process by the vehicle-mounted device 10.

The current location displaying process is executed continuously as long as the navigation function of the vehicle-mounted device 10 is in effect.

First the location measuring device 29 acquires the location information (latitude and longitude) for the current location by receiving location measurement signals that are transmitted by satellites for location measurement (Step S1). Following this, the mapping processing unit 123 reads the navigation map 300 that includes the current location from the navigation map database 131 that is stored in the storing unit 130, t, and maps the location information for the current location onto the navigation map 300. That is, it converts the location information for the current location into navigation map coordinates (X, Y) that represent the current location on the navigation map 300 (Step S2).

Following this, the mapping processing unit 123 references the corresponding deformed map information that has been added to the navigation map 300 that was read out from the navigation map database 131, to determine whether or not there is a deformed map 310 that corresponds to the navigation map 300, and whether or not the current location is within the display area of the deformed map 310, that is, whether or not there is a deformed map 310 that includes the current location (Step S3). If here the determination is that there is a corresponding deformed map 310 and that the current location is within the display area thereof (YES in Step S3), the mapping processing unit 123 reads out, from the conversion table database 133, the conversion table 320 that corresponds to the deformed map 310, and uses the conversion table 320 to convert, into deformed map coordinates (x, y), the navigation map coordinates (X, Y) (which were converted in Step S2) that correspond to the location information for the current location (Step S4).

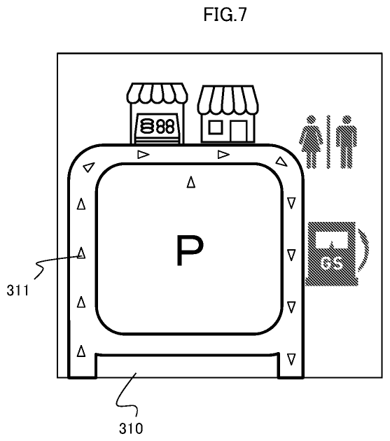

Next, the display controlling unit 124 reads the deformed map 310 that includes the current location, places the mark 311 (FIG. 7) that indicates the current location at the deformed map coordinates (x, y) that correspond to the location information for the current location from the deformed map database 132, and displays the result on the display 21 (Step S5).

FIG. 7 shows an example display of a deformed map 310 that is displayed on the display 21 through Step S5. As shown in this figure, the mark 311 that indicates the current location can be displayed at a suitable location on the deformed map 310.

Note that if the mapping processing unit 123 determinates that there is no deformed map 310 that corresponds to the navigation map 300 that has been read out from the navigation map database 131 or that, despite the existence of a corresponding deformed map 310, the current location is not within the display area thereof (NO in Step S3), the display controlling unit 124 places a mark 301 (FIG. 3) that indicates the current location at the navigation map coordinates (X, Y) (converted from the location information in Step S2) that correspond to the current location in the navigation map 300 (which was read out from the navigation map database 131 in Step S2) that includes the current location, and displays the result on the display 21 (Step S6). Processing thereafter returns to Step S1, repeating from Step S1.

The current location displaying process, explained above, enables a mark that indicates the current location to be displayed at an appropriate location on the deformed map, and to not be displayed at an inappropriate location.

### Modified Example

While in the present embodiment a conversion table was used for displaying the current location on the deformed map, the conversion table may be used instead for displaying, on the deformed map, an image (an icon, or the like) a structure, the location of an accident or traffic slowdown, or the like, that can serve as a landmark.

While in the present embodiment, the location information (latitude and longitude), the navigation map coordinates (X, Y), the deformed map coordinates (x, y), and the conversion table were two-dimensional, they may instead be expanded into three dimensions or four dimensions by adding height and/or a direction thereto. When height is added, this allows handling of a case for displaying the current location on a floor map of an individual floor of a building that corresponds to the deformed map. Moreover, when a direction is added, this enables appropriate display of the direction of travel, or the like, on the deformed map.

While in the present embodiment, the deformed map 310 was drawn or generated as a single image, instead, for example, a deformed map 310 may be generated through placing icons that indicate facilities (which in this case are stores, restrooms, gas stations, parking lots, and the like) on a deformed roadmap where the roads in the navigation map 300 have been abstracted. This allows the deformed map 310 to be generated more easily than when drawing or generating as a single image. Additionally, permission information may be added to the icons for the individual facilities as to whether or not the mark indicating the current location can or cannot be superimposed. When displaying the deformed map 310, the display controlling unit 124 places the icons of the facilities onto the deformed roadmap, and if the deformed map coordinates (x, y) that correspond to the current location are on the location of an icon of a facility, the display controlling unit 124 references the permission information that has been added to the icon for the facility to display the icon that indicates the current location superimposed onto the icon for the facility if the information indicates that this is permitted. Conversely, if the information indicates that this is not permitted, the display controlling unit 124 displays the icon that indicates the current location without superimposing it on the icon of the facility, through correcting the deformed map coordinates (x, y) that correspond to the current location to a location that avoids the location of the icon of the facility (for example, to be near to the icon).

The effects described in the present Specification are merely illustrative, and are not limiting, and there may be other effects as well.

The present invention is not limited to the embodiments according to above, but rather includes a variety of modified examples. For example, while the embodiments according to above were explained in detail for ease in understanding the present invention, The present invention is not limited to necessarily being provided with all of the structures that were described. Additionally, a part of the structures in a given embodiment may be substituted for the structures in another embodiment, or structures of another embodiment may be added to structures of a given embodiment. Additionally, for some of the structures of each embodiment, additions, omissions, or substitutions of other structures is also possible.

Furthermore, each of the structures, functions, processing units, processing means, or the like, described above, may have some or all thereof achieved in hardware through, for example, designing as an integrated circuit. Furthermore, each of the structures, functions, and the like, described above, may be achieved in the software through a processor interpreting and executing a program to achieve those functions. Information such as programs, determination tables, files, and the like, for achieving the individual functions may be placed in a memory, a storing device such as an HDD or SSD, or a recording medium such as an IC card, SD card, DVD, or the like. Additionally, control lines or data lines are noted when deemed necessary for the explanation, but not all control lines or data lines in the product are necessarily shown. In practice, substantially all of the structures can be thought of as being mutually connected.

The present invention is not only an information processing device, but rather may be provided in a variety of forms, such as an information processing method by an information processing device, a program that can be read by a computer, or the like.

### EXPLANATION OF REFERENCE SYMBOLS

10: Vehicle-Mounted Device
11: Processing Device
21: Display
23: Storing Device
24: Audio Device
25: Inputting Device
26: Communicating Device
27: Vehicle Velocity Sensor
28: Gyro Sensor
29: Location Measuring Device
30: FM Multiplexed Broadcast Receiving Device
31: Beacon Receiving Device
32: Imaging Device
115: Bus
120: Processing Unit
121: Input Receiving Unit
122: Route search Unit
123: Mapping Processing Unit
124: Display Controlling Unit
130: Storing Unit
131: Navigation Map Database
132: Deformed Map Database
133: Conversion Table Database
241: Microphone
242: Speaker
251: Touch Panel
252: Switch
300: Navigation Map
301: Mark
310: Deformed Map
311: Mark
320: Conversion Table

1. An information processing device, comprising:
a measuring unit for measuring location information for a current location;
a mapping processing unit for converting the location information for the current location into first map coordinates in a first map, for a navigation application, that includes the current location, and for using a conversion table to convert the first map coordinates into second map coordinates in a second map wherein the first map has been abstracted; and
a display controlling unit for displaying, on a display, the second map, on which has been placed, at the second map coordinates, a mark that indicates the current location, wherein:
the second map coordinates in a second coordinate system with the same scale as the first coordinate system, provided in the second map, are recorded in the conversion table in correspondence with the first map coordinates of the first coordinate system that are provided in the first map.

2. The information processing device according to claim 1, wherein:
the display controlling unit displays the second map in which the mark is arranged in the second map coordinate is displayed on the display if there is the second map that includes the current location, and
the first map in which the mark is arranged in the first map coordinate is displayed on the display if there is no second map that includes the current location.

3. The information processing device according to claim 1, wherein:
the second map coordinates are recorded in the conversion table in a 1:1 or many:1 correspondence with the first map coordinates.

4. The information processing device according to claim 1, wherein:
the second map coordinates, which avoid a region on the second map wherein the mark is to not be placed, are recorded in the conversion table in correspondence with the first map coordinates.

5. The information processing device according to claim 1, wherein:
the display controlling unit displays the second map through placing a facilities icon on a deformed roadmap wherein the roads in the first map are abstracted.

6. The information processing device according to claim 5, wherein:
permission information that indicates whether or not superimposition of a mark on the facilities icon is permitted is added to the facilities icon; and
the display controlling unit references the permission information if the second map coordinates that corresponds to the current location are on the location of the facilities icon in the second map, and corrects the second map coordinates corresponding to the current location to a location that avoids the location of the facilities icon if it does not permitted.

7. The information processing device according to claim 1, wherein:
a height and/or direction element is included in addition to two-dimensional elements in the location information for the current location, the first map coordinates, the second map coordinates, and the conversion table.
